(19) United States
(12) Patent Application Publication
(10) Pub. No.: US 2018/0286553 A1
(43) Pub. Date: Oct. 4, 2018

(54) COIL DEVICE

(71) Applicant: TDK CORPORATION, Tokyo (JP)

(72) Inventors: Tsutomu KOBAYASHI, Tokyo (JP); Toshio TOMONARI, Tokyo (JP); Kiyofumi FUJIWARA, Tokyo (JP); Emi ITO, Tsuruoka-city (JP)

(73) Assignee: TDK CORPORATION, Tokyo (JP)

(21) Appl. No.: 15/903,696

(22) Filed: Feb. 23, 2018

(30) Foreign Application Priority Data
Mar. 29, 2017 (JP) 2017-065599

(51) Int. Cl. H01F 17/04; H01F 27/24; H01F 27/28; H01F 27/00; H01F 27/29

(52) U.S. Cl. CPC H01F 17/045; H01F 27/24; H01F 27/292; H01F 27/006; H01F 27/2823

(57) ABSTRACT

A coil device includes a core, an inner coil portion, an outer coil portion, and an intermediate resin layer. The core includes a winding portion and a flange positioned at an end of the winding portion in an axial direction. The inner coil portion is constituted by winding a first wire around the winding portion. The outer coil portion is constituted by winding a second wire outside the inner coil portion. The intermediate resin layer exists between the inner coil portion and the outer coil portion.

### BACKGROUND OF THE INVENTION

### 1. Field of the Invention

The present invention relates to a coil device capable of being used as a coupled inductor (coupling inductor), for example.

### 2. Description of the Related Art

Maintenance of L value and reduction of coupling coefficient are required to be adjusted in, for example, surface-mount coil devices. As shown in Patent Document 1 below, for example, coupling coefficient can be reduced by winding a primary wire and a secondary wire disposed separately from each other in a coaxial center extended line.

Since a primary wire and a secondary wire are wound around a winding portion separately from each other in a coaxial center extended line, however, a height of the winding portion in its axial direction needs to be maintained, and there is thereby a problem of low profile. In addition, the structure of Patent Document 1 has a problem of lowering of inductance.

Patent Document 1: JP 2001-338819 A

### SUMMARY OF THE INVENTION

The present invention has been achieved under such circumstances. It is an object of the invention to provide a coil device having a sufficient inductance and capable of reducing coupling coefficient and achieving low profile.

To achieve the above object, the coil device according to the present invention is a coil device comprising:

a core including a winding portion and a flange positioned at an end of the winding portion in an axial direction;

an inner coil portion constituted by winding a first wire around the winding portion;

an outer coil portion constituted by winding a second wire outside the inner coil portion; and

an intermediate resin layer existing between the inner coil portion and the outer coil portion.

In the coil device according to the present invention, the intermediate resin layer exists between the inner coil portion and the outer coil portion, and a coupling coefficient between these coil portions can be thereby small. The outer coil portion is positioned around the outer circumference of the inner coil portion, and it is thereby possible to reduce a height of the winding core in the axial direction and achieve a low profile of the coil device. Moreover, it is possible to freely determine the winding number of the inner coil portion and the winding number of the outer coil portion and is possible to maintain a sufficient inductance. Incidentally, it is preferred that the inner coil portion and the outer coil portion respectively be a primary coil and a secondary coil of a transformer or an inductor. On the contrary, however, the inner coil portion and the outer coil portion may be respectively a secondary coil and a primary coil of a transformer or an inductor.

Preferably, a resin constituting the intermediate resin layer also exists between a first leading portion of the first wire led from the inner coil portion and a second leading portion of the second wire led from the outer coil portion. This configuration can securely insulate the first leading portion and the second leading portion and can reduce a coupling coefficient.

Preferably, the resin constituting the intermediate resin layer is also inserted into a space between the winding portion and the inner coil portion. The intermediate insulating layer may be formed by winding a first coil around the winding core so as to form the inner coil portion and thereafter winding a resin tape therearound, but is preferably formed by applying a resin with a coating method.

When the intermediate insulating layer is formed by a coating method, the resin constituting the intermediate insulating layer is inserted into the space between the winding core and the inner coil portion, and the inner coil portion can be fixed securely to the winding core. In addition, when the intermediate insulating layer is formed by a coating method, the intermediate insulating layer can have a uniform thickness, and the second wire for forming the outer coil portion is wound easily, compared to when the intermediate insulating layer is formed by a resin tape.

Preferably, the resin constituting the intermediate resin layer contains an intermediate magnetic material. When the resin contains a magnetic material, the coil device has an improved inductance (L value).

Preferably, an outer circumference of the outer coil portion is covered with an external resin. When the outer circumference of the outer coil portion is covered with an external resin, the wires constituting the coil portions are effectively protected while the coil device is being handled.

The external resin may contain an external magnetic material. When the external resin also contains a magnetic material, an L value can be further improved. The intermediate magnetic material and the external magnetic material are preferably the same kind of magnetic material, but may be magnetic materials differing from each other. The resin constituting the intermediate insulating layer and the external resin are preferably the same kind of resin, but may be resins differing from each other.

The flange may comprise a first terminal electrode connected with a tip of the first leading portion of the first wire, and a second terminal electrode connected with a tip of the second leading portion of the second wire. The coil device is easily attached as a surface-mount type coil to a circuit board or so. Preferably, the first terminal electrode and the second terminal electrode are formed on side surfaces of the flange facing each other. This is because the first terminal electrode and the second terminal electrode are insulated easily.

### BRIEF DESCRIPTION OF THE DRAWINGS

FIG. 1A is a partially-transparent schematic view of a cross section of a coil device according to an embodiment of the present invention.

FIG. 1B is a partially-transparent schematic view of a cross section of the coil device shown in FIG. 1A when viewed from a different angle.

FIG. 2 is a schematic cross-sectional view taken along II-II line shown in FIG. 1A.

FIG. 3 is a graph showing a relation between frequency and coupling coefficient of a coil device according to an embodiment of the present invention.

### DETAILED DESCRIPTION OF THE PREFERRED EMBODIMENT

Hereinafter, the present invention is described based on an embodiment shown in figures.

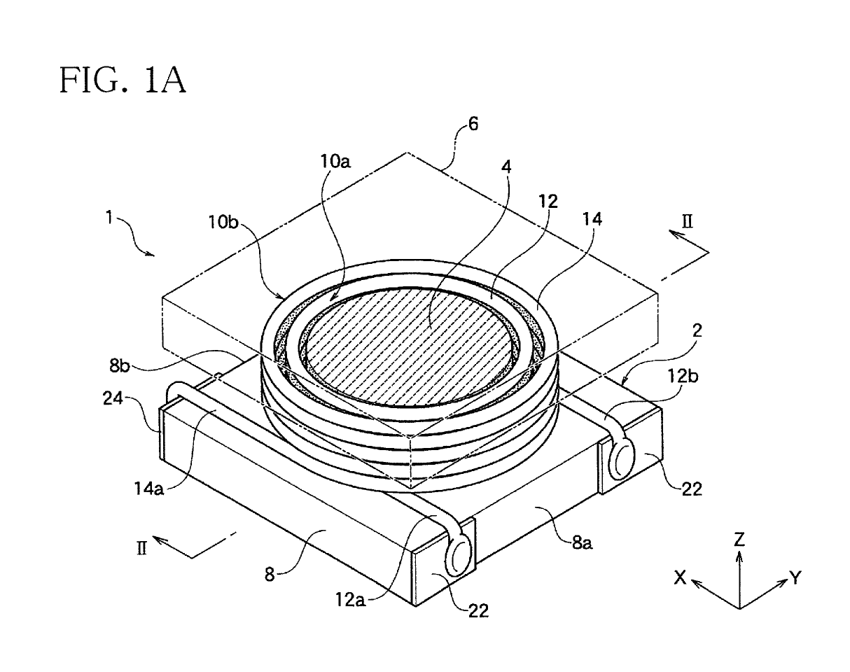

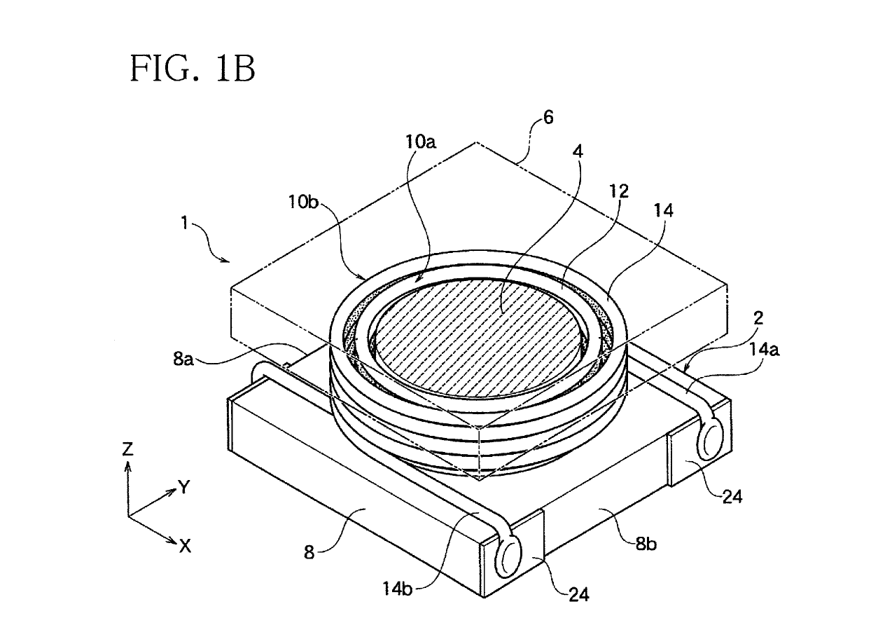

As shown in FIG. 1A and FIG. 1B, a coil device 1 according to an embodiment of the preset invention has a magnetic core 2. The magnetic core 2 has a winding core 4 wound by a first wire 12 and a second wire 14 and flanges 6 and 8 respectively positioned on both ends of the winding core 4 in an axial direction (Z-axis direction). The winding core 4 and the flanges 6 and 8 are formed integrally.

In the present embodiment, the winding core 4 has a column shape, and the first wire 12 is wound around the winding core 4 by single layer or multiple layers so as to constitute an inner coil portion 10a. The winding core 4 is, however, not limited to having a column shape, and the winding core 4 may have an ellipse column shape, a prism shape, or another shape. The flanges 6 and 8 have a rectangular plate shape in the present embodiment, but the flanges 6 and 8 may have any shape whose size is larger than a size of the winding core 4, such as polygonal plate shape, disk shape, and elliptical plate shape.

The flanges 6 and 8 do not need to have the same shape, but have the same shape in the present embodiment. The coil device 1 has any size, but has a length (X-axis direction) of 0.4 to 20 mm, a width (Y-axis direction) of 0.2 to 20 mm, and a height (Z-axis direction) of 0.2 to 15 mm. Incidentally, the X-axis, the Y-axis, and the Z-axis are perpendicular to each other.

In the winding core 4, the inner coil portion 10a is formed by firstly winding the first wire 12, and an intermediate insulating layer 20 having a predetermined thickness “t” is formed outside the inner coil portion 10a. The predetermined thickness “t” is not limited, but is preferably 10 μm to 2 mm. The larger the predetermined thickness “t” is, the smaller a coupling coefficient can be. For example, when the predetermined thickness “t” is 150 μm or more, a coupling coefficient can be 0.45 or less.

The intermediate insulating layer 20 is formed by forming the inner coil portion 10a around an outer circumference of the winding core 4 and thereafter applying a resin onto the inner coil portion 10a. This resin is applied by any method. For example, this resin is applied by a spray or by a dispenser while the core 2 is being rotated around its axis. This resin is not limited, but is preferably acrylic resin, epoxy resin, silicone resin, or the like.

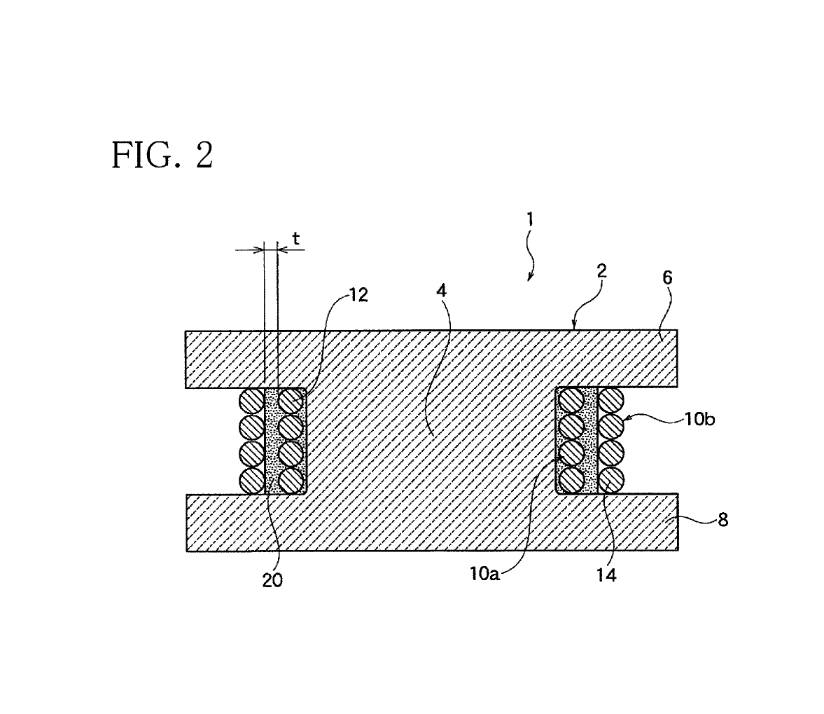

When a resin is applied on the inner coil portion 10a, as shown in FIG. 2, the intermediate insulating layer 20 having a predetermined thickness is formed around the outer circumference of the inner coil portion 10a, and the resin constituting the intermediate insulating layer 20 is inserted into a space between the winding core 4 and the inner coil portion 10a and a space among the wire 12. As shown in FIG. 1A and FIG. 1B, the resin constituting the intermediate insulating layer 20 also exists between first leading portions 12a and 12b of the first wire 12 and second leading portions 14a and 14b of the second wire 14 mentioned below.

As shown in FIG. 2, the second wire 14 is wound around an outer circumferential surface of the intermediate insulating layer 20 having a predetermined thickness “t” so as to form an outer coil portion 10b. The second wire 14 constituting the outer coil portion 10b may have a diameter that is identical to a diameter of the first wire 12, but may have a diameter that is different from a diameter of the first wire 12. The first wire 12 and the second wire 14 are preferably constituted by the same material, but are not necessarily constituted by the same material.

The wires 12 and 14 are any wire, such as single wire and stranded wire, and are constituted by copper, silver, gold, alloy of these, or the like. The wires 12 and 14 are not limited to having a circular cross section, and may have a rectangular cross section. The wires 12 and 14 may be covered with insulation at their parts other than tips of the leading portions 12a, 12b, 14a, and 14b connected to terminal electrodes 22 and 24 mentioned below. The wires 12 and 14 may be wound around the winding core 4 by edgewise winding or crosswise winding.

As shown in FIG. 1A, the leading portions 12a and 12b on both ends of the first wire 12 constituting the inner coil portion 10a are led to a first end 8a of the flange 8 in the X-axis direction, and are connected to first terminal electrodes 22 respectively formed on both sides of the first end 8a in the Y-axis direction. As shown in FIG. 1B, the leading portions 14a and 14b on both ends of the second wire 14 constituting the outer coil portion 10b are led to a second end 8b of the flange 8 in the X-axis direction, and are connected to second terminal electrodes 24 respectively formed on both sides of the second end 8b in the Y-axis direction.

For example, the terminal electrodes 22 and 24 may be formed by metal plating of the flange 8 or may be formed by adhering a metal terminal to the flange 8. The leading portions 12a, 12b, 14a, and 14b are connected to the terminal electrodes 22 and 24 by any method, such as soldering, silver brazing, thermocompression bonding, resistance welding, and laser welding.

In the present embodiment, the magnetic core 2 is composed of any material, such as a metal and a soft magnetic material of ferrite etc. For example, the magnetic core 2 may be composed of a pressed powder green compact, such as Fe—Ni alloy powder, Fe—Si alloy powder, Fe—Si—Cr alloy powder, Fe—Si—Al alloy powder, permalloy powder, amorphous powder, and Fe powder. These ferromagnetic metals have a saturated magnetic flux density that is larger than a saturated magnetic flux density of ferrite and have DC superposition characteristics maintained to high magnetic field.

In the coil device 1 according to the present embodiment, the intermediate insulating layer 20 exists between the inner coil portion 10a and the outer coil portion 10b, and a coupling coefficient between the coil portions 10a and 10b can be thereby small. The outer coil portion 10b is positioned around the outer circumference of the inner coil portion 10a, and it is thereby possible to reduce a height of the winding core 4 in the axial direction and achieve a low profile of the coil device 1. Moreover, it is possible to freely determine the winding number of the inner coil portion 10a and the winding number of the outer coil portion 10b and is possible to maintain a sufficient inductance. Incidentally, it is preferred that the inner coil portion 10a and the outer coil portion 10b respectively be a primary coil and a secondary coil of a transformer or an inductor. On the contrary, however, the inner coil portion 10a and the outer coil portion 10b may be respectively a secondary coil and a primary coil of a transformer or an inductor.

In the present embodiment, the resin constituting the intermediate insulating layer 20 also exists between the first leading portions 12a and 12b of the first wire 12 led from the inner coil portion 10a and the second leading portions 14a and 14b of the second wire 14 led from the outer coil portion 10b. This configuration can securely insulate the first leading portions 12a and 12b and the second leading portions 14a and 14b and can reduce a coupling coefficient.

In the present embodiment, the resin constituting the intermediate insulating layer 20 is also inserted into the space between the winding core 4 and the inner coil 10a. The intermediate insulating layer 20 is formed by winding the first coil 10a around the winding core 4 so as to form the inner coil portion 10a and thereafter applying the resin thereto with a coating method.

Since the intermediate insulating layer 20 is formed by a coating method, the resin constituting the intermediate insulating layer 20 is inserted into the space between the winding core 4 and the inner coil portion 10a, and the inner coil portion 10a can be fixed securely to the winding core 4. In addition, since the intermediate insulating layer 20 is formed by a coating method, the intermediate insulating layer 20 can have a uniform thickness “t”, and the second wire 14 for forming the outer coil portion 10b is wound easily, compared to when the intermediate insulating layer 20 is formed by a resin tape.

Moreover, the resin constituting the intermediate insulating layer 20 preferably contains an intermediate magnetic material. This intermediate magnetic material may be a metal powder, a ferrite powder, or the like, and is a magnetic powder that is similar to a magnetic material constituting the magnetic core 2, but is not necessarily the same. When the intermediate insulating layer 20 contains the intermediate magnetic material, the coil device 1 has an improved inductance (L value). For example, when the intermediate insulating layer 20 contains the intermediate magnetic material, the inner coil portion 10a has an improved L value, and the outer coil portion 10b has an improved L value.

In the present embodiment, since the flange 8 has a pair of first terminal electrodes 22 and a pair of second terminal electrodes 24, the coil device 1 is easily attached as a surface-mount type coil to a circuit board or so. The first terminal electrodes 22 and the second terminal electrodes 24 are formed on the side surfaces (end surfaces 8a and 8b) of the flange 8 facing each other in the X-axis direction, and are thereby insulated easily.

Incidentally, the present invention is not limited the above-mentioned embodiment, and may be changed variously within the scope of the present invention.

For example, the outer circumference of the outer coil portion 10b may be covered with an exterior resin. When the outer circumference of the outer coil portion 10b is covered with an exterior resin, the wires 12 and 14 constituting the coil portions 10a and 10b are effectively protected while the coil device 1 is being handled.

The external resin may contain an external magnetic material. This external magnetic material is similar to the intermediate magnetic material, but is not necessarily the same. When the exterior resin contains a magnetic material, an L value can be further improved. The resin constituting the intermediate insulating layer and the exterior resin are preferably the same kind of resin, but may be resins that are different from each other.

### EXAMPLE

Hereinafter, the present invention is described based on a further detailed example, but is not limited to the example.

### Example 1

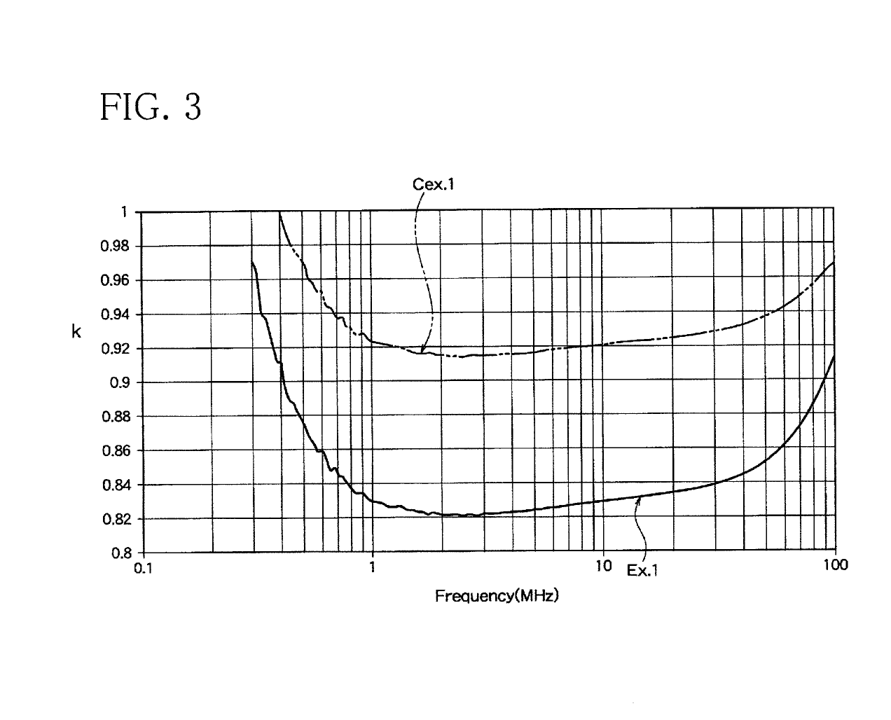

A coil device shown in FIG. 1A to FIG. 2 was manufactured. The thickness of an intermediate insulating layer 20 was 150 μm. This coil device was measured with respect to coupling coefficient “k” by changing frequency. A curve of ex. 1 in FIG. 3 shows the measurement results.

### Comparative Example 1

A coil device was manufactured in a similar manner to Example 1 except that no intermediate insulating layer 20 was formed, and that an exterior resin was applied to an outer circumference of an outer coil. This coil device was measured with respect to coupling coefficient “k” by changing frequency in a similar manner to Example 1. A curve of Cex. 1 in FIG. 3 shows the measurement results.

### Evaluation

As shown in FIG. 3, it was confirmed that a coupling coefficient can be reduced over a wide range of frequency in Example 1, compared to Comparative Example 1.

### NUMERICAL REFERENCES

1 . . . coil device
2 . . . magnetic core
4 . . . winding portion
6, 8 . . . flange
10a . . . inner coil portion
10b . . . outer coil portion
12 . . . first wire
14 . . . second wire
20 . . . intermediate insulating layer
22 . . . first terminal electrode
24 . . . second terminal electrode

1. A coil device, comprising:
a core including a winding portion and a flange positioned at an end of the winding portion in an axial direction;
an inner coil portion constituted by winding a first wire around the winding portion;
an outer coil portion constituted by winding a second wire outside the inner coil portion; and
an intermediate resin layer existing between the inner coil portion and the outer coil portion.

2. The coil device according to claim 1, wherein a resin constituting the intermediate resin layer also exists between a first leading portion of the first wire led from the inner coil portion and a second leading portion of the second wire led from the outer coil portion.

3. The coil device according to claim 1, wherein a resin constituting the intermediate resin layer is also inserted into a space between the winding portion and the inner coil portion.

4. The coil device according to claim 2, wherein the resin constituting the intermediate resin layer is also inserted into a space between the winding portion and the inner coil portion.

5. The coil device according to claim 1, wherein a resin constituting the intermediate resin layer contains an intermediate magnetic material.

6. The coil device according to claim 1, wherein an outer circumference of the outer coil portion is covered with an exterior resin.

7. The coil device according to claim 6, wherein the exterior resin contains an external magnetic material.

8. The coil device according to claim 1, wherein the flange comprises:
a first terminal electrode connected with a tip of the first leading portion of the first wire; and
a second terminal electrode connected with a tip of the second leading portion of the second wire.
